(19) United States
(12) Patent Application Publication
(10) Pub. No.: US 2007/0268646 A1
(43) Pub. Date: Nov. 22, 2007

(54) METHOD AND DEVICE FOR MONITORING DETECTOR LINE OF FIRE DETECTION SYSTEM FOR FAULTS

(75) Inventor: Harald SCHERMANN, Unterschweinbach (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/747,672

(22) Filed: May 11, 2007

(30) Foreign Application Priority Data
May 11, 2006 (EP) EP06113828

(51) Int. Cl. H02H 9/06

(52) U.S. Cl. 361/118

(57) ABSTRACT

A limit indicator technology based detector line of a fire detection system has a line current applied to it during operation and has a final element formed by a TVS diode. At least one of the line current and the line voltage are monitored. Faults of the detector line are detected by a brief increase and a brief reduction in the line current.

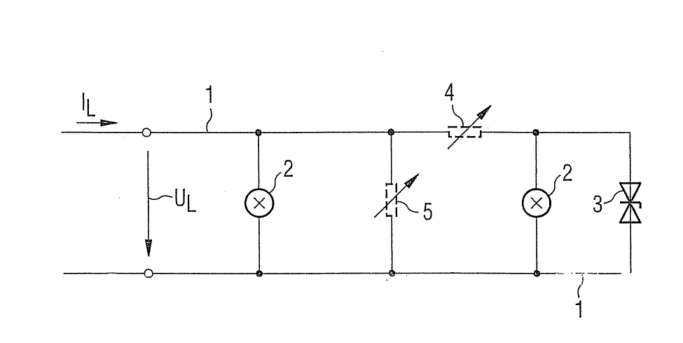

### CROSS REFERENCE TO RELATED APPLICATIONS

This application is based on and hereby claims priority to European Application No. EP06113828 filed on May 11, 2006, the contents of which are hereby incorporated by reference.

### BACKGROUND

Described below is a method for monitoring a limit indicator technology based detector line of a fire detection system for faults, wherein the detector line has a line current applied to during operation and has a final element formed by a TVS diode, the line current and/or line voltage are monitored and the line current is briefly increased for the purpose of detecting faults.

Limit indicator technology (GMT technology), which is also referred to as direct current indicator technology or collective technology (in the latter case reference is made to what are termed collective detector lines and collective fire detectors), has been well-known for a long time in fire detection systems and is very cost-effective compared with fire detection systems with individually addressable detectors. During operation a line current is applied to the detector lines connected to a control center, to which detector lines the different fire detectors are connected, resulting in a line voltage which drops in the event of an alarm. The final element serves for enabling an interruption in the detector line to be detected.

In fire detection systems the detector lines have to be monitored constantly for faults and faults must be signaled without great delay so that they can be rectified promptly. The aim is to keep the availability of the system and the quality of the protection as high as possible and downtimes due to repairs as short as possible. Examples of possible faults are in particular wire breakage or short-circuit and “creeping wire breakage” or “creeping short circuit”.

In known detector lines of GMT technology a resistor is used as the final element. In order to be able to reliably identify an interruption on the detector line, a current which is substantially greater than the current flowing through the fire detectors must flow through this resistor, thus necessitating an emergency storage battery of a specific minimum size. In order to reduce the current drain it has been proposed that an overvoltage protection diode or TVS diode (TVS=transient voltage suppressor) be used as the final element instead of the resistor, such a diode being distinguished from the so-called “active final elements” in that it is more robust, cheaper, smaller, and mechanically easier to handle. Although TVS diodes enable wire breakages and short-circuits to be detected, they have the disadvantage that due to their large temperature variation it is not possible to deduce a creeping short-circuit or a creeping wire breakage from a change in the line voltage.

A creeping wire breakage can be detected by a brief increase in the line current. In this case it is assumed that in the event of such a temporary increase in the line current the voltage at the TVS diode and the current into the fire detectors remain the same. With this brief increase in the line current the line voltage increases proportionally to the line resistance, thereby enabling a creeping wire breakage to be detected by measurement of the line voltage.

In the case of a creeping short-circuit the line voltage drops, which could be detected per se, but cannot be differentiated from a dropping of the temperature at the TVS diode and consequently is not practicable.

### SUMMARY

An aspect is to improve a device of the type cited in the introduction in such a way that a creeping short-circuit will also be reliably detected.

Such a device is improved in that in addition the line current is briefly reduced for the purpose of detecting further faults.

A further fault detected is a creeping short-circuit. A creeping short-circuit can be detected by the brief lowering of the line current. In this case the TVS diode receives too little current to stabilize the rated voltage, with the result that the line voltage drops disproportionately. Preferably, the brief lowering of the line current takes place periodically.

The device described below monitors a limit indicator technology based detector line of a fire detection system, having detectors connected to the detector line, a control center for applying line current to the detector line, and a monitor for at least one of the line current and the line voltage. A final element of the detector line is formed by a TVS diode and the line current is briefly increased for the purpose of detecting faults.

In addition the line current is briefly reduced for the purpose of detecting further faults. Preferably, the brief lowering of the line current takes place periodically.

The process of monitoring for faults may be controlled by a microcontroller. The measured values of the line current and the line voltage may be converted in an A/D converter and subsequently processed further in the microcontroller.

### BRIEF DESCRIPTION OF THE DRAWINGS

These and other objects and advantages will become more apparent and more readily appreciated from the following description of the preferred embodiments, taken in conjunction with the accompanying drawings of which:

The only drawing is a circuit diagram which shows a section from a limit indicator technology based detector line of a fire detection system for monitoring the detector line for faults.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

In the drawing, the two lines designated by reference numeral 1 symbolize a detector line, while the fire detectors connected thereto (only two of which are shown) are designated by reference numeral 2. The fire detectors 2 may be smoke detectors, heat detectors, flame detectors, fire gas detectors, or combinations of these, or manual alarm call points. The detector line 1 is what is referred to as a spur which leads away from a control center (not shown) and is terminated by a final element formed by an overvoltage protection diode or TVS diode 3.

The illustrated detector line is based on limit indicator technology, also referred to as direct current indicator technology or collective technology, in which the individual detectors cannot be addressed and the detector(s) triggering an alarm cannot be identified. Needless to say, however, the control center identifies the respective detector line. A direct current I_{L} is fed into the detector line 1 by the control center by a current source (not shown). The line voltage U_{L} then sets itself and in normal conditions is dependent on the TVS diode 3 and the line resistance.

The TVS diode sets a precisely defined voltage of, for example, 20V at the end of the detector line 1. When a detector 1 trips it draws more current, even simply to activate its alarm indicator, and the line voltage U_{L} drops. If the line voltage U_{L} drops below a specific value, an alarm is detected.

Basically, four types of fault can occur on the detector line 1: wire breakage, short-circuit, creeping wire breakage, and creeping short-circuit. Wire breakage and short-circuit can be easily and reliably detected by measurement of the line voltage U_{L}. In contrast, there are problems in detecting creeping wire breakage and creeping short-circuit, since TVS diodes have a relatively large temperature variation, with the result that it is not possible unequivocally to infer a creeping wire breakage or creeping short-circuit when there is a change in the line voltage U_{L}.

The drawing shows two resistors represented by a dashed line: a series resistor 4, which symbolizes the line resistance with a creeping wire breakage, and a parallel resistor 5, which symbolizes the line resistance with a creeping short-circuit.

A creeping wire breakage can be detected by a brief increase in the line current I_{L}. In this case it is assumed that in the event of such a temporary increase in the line current the voltage at the TVS diode 3 and the current into the fire detectors remain the same. With this brief increase in the line current I_{L} the line voltage U_{L} increases proportionally to the series resistor 4, thereby enabling a creeping wire breakage to be detected by measurement of the line voltage U_{L}.

In the case of a creeping short-circuit the voltage at the parallel resistor 5 increases due to an increase in the line current I_{L}, though this manifests itself like a creeping wire breakage. As far as fault detection is concerned, this circumstance would not be significant, since a fault has of course been detected, but for the service technician who has to repair the fault it is important to know which type of fault is involved.

Reliable detection of a creeping short-circuit is, however, made possible by a brief lowering of the line current, for this causes the TVS diode 3 to receive too little current in order to stabilize the rated voltage of 20V, with the result that the line voltage U_{L} drops disproportionately. The reduction in the line current I_{L} is automatically repeated periodically and a detected fault is reported to the control center.

The entire fault monitoring process is controlled by a microcontroller (not shown). The measured values of the line current I_{L} and the line voltage U_{L} are converted by an A/D converter (not shown) and processed further in the microcontroller. In order to eliminate faults such as are caused, for example, by EMC radiation, an average is taken over a plurality of measured values during the evaluation.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for monitoring a limit indicator technology based detector line of a fire detection system for faults, comprising:
applying a line current to the detector line during operation, the detector line having a final element formed by a TVS diode;
monitoring at least one of the line current and a line voltage; and
briefly increasing and briefly decreasing the line current, enabling detection of faults by said monitoring.

2. The method as claimed in claim 1, wherein one of the faults detected by decreasing the line current is a creeping short-circuit.

3. The method as claimed in claim 2, wherein said briefly decreasing the line current is repeated periodically.

4. The method as claimed in claim 3, further comprising averaging measured values, obtained during a period of said monitoring of the at least one of the line current and the line voltage.

5. The method as claimed in claim 2, further comprising averaging measured values, obtained during a period of said monitoring of the at least one of the line current and the line voltage.

6. The method as claimed in claim 1, further comprising averaging measured values, obtained during a period of said monitoring of the at least one of the line current and the line voltage.

7. A device for monitoring a limit indicator technology based detector line of a fire detection system, comprising:
detectors connected to the detector line, the detector line having a TVS diode as a final element;
a control center applying a line current to the detector line; and
means for monitoring at least one of a line current and a line voltage while the line current is increased briefly and reduced briefly enabling detection of faults.

8. The device as claimed in claim 7, wherein said means briefly reduces the line current periodically.

9. The device as claimed in claim 8, wherein said means comprises a microcontroller controlling the monitoring for the faults.

10. The device as claimed in claim 9,
wherein said means further comprises an analog/digital converter, coupled to or integrated in said microcontroller, converting measured values of the at least one of the line current and the line voltage.

11. The device as claimed in claim 10, wherein said microcontroller averages a plurality of the measured values of the at least one of the line current and the line voltage.
